(19) United States
(12) Patent Application Publication
(10) Pub. No.: US 2014/0256352 A1
(43) Pub. Date: Sep. 11, 2014

(54) METHOD FOR MEASURING POSITION OF USER TERMINAL

(71) Applicants: Young Jun Kim, Seoul (KR); Young Chal Ko, Seoul (KR)

(72) Inventors: Young Jun Kim, Seoul (KR); Young Chal Ko, Seoul (KR)

(73) Assignee: Intellectual Discovery Co., Ltd., Seoul (KR)

(21) Appl. No.: 14/347,114

(22) PCT Filed: Sep. 6, 2012
(86) PCT No.: PCT/KR2012/007154

§ 371 Date: May 29, 2014

(30) Foreign Application Priority Data
Sep. 30, 2011 (KR) 10-2011-0100077

(51) Int. Cl. G01S 5/04; H04W 24/00

(52) U.S. Cl. CPC G01S 5/04; H04W 24/00
USPC 455/456.1

(57) ABSTRACT

A method for measuring a position of a user terminal is provided. The method includes selecting one or more anchor nodes for measuring the position of the user terminal, selecting a relay terminal from neighboring terminals of the user terminal, each of the neighboring terminals securing a Line Of Sight (LOS) with the user terminal and having location information thereof, and measuring the position of the user terminal using the one or more anchor nodes and the relay terminal.

### TECHNICAL FIELD

The present invention relates to a method for measuring the position of a user terminal, and more particularly, to a method for measuring the position of a user terminal using a relay terminal.

### BACKGROUND ART

A typical radio positioning technique includes a scheme using a Global Positioning System (GPS), a Time Of Arrival (TOA) scheme using an arrival time of electro-magnetic waves, which is a principle of position recognition, a scheme using infrared rays, ultrasonic waves, and Radio Frequency (RF), and a scheme using Radio Frequency Identification (RFID).

Among these schemes, the positioning technique based on the TOA of electro-magnetic waves performs position measurement as followings. Firstly, a transmitter transmits a signal conveys a timestamp which issued by the transmitter. After that a receiver estimates the distance between the transmitter and the receiver by comparing a signal reception time with a signal transmission time recorded on the timestamp. Such a TOA scheme needs at least three anchor nodes or more which transmit Pseudo Random Noise (PRN) signals to estimate the distance.

Each of the anchor nodes generates different PRN signals. Assuming that all anchor nodes and a terminal are aware of types of PRN signals generated by the anchor nodes and the positions of the anchor nodes. The distance Ri between the terminal and an i-th anchor node, measured using the PRN signals, may be indicated by:

MathFigure 1

Rᵢ=C*tᵢ=Dᵢ+nᵢ+eᵢ(i=1,2,3, . . . , N) [Math.1]

where C denotes the speed of light, Di denotes an actual distance, ni denotes a measurement error, and ei denotes a non-Line Of Sight (LOS) error when a LOS is not secured.

The measurement error ni is obtained by modeling various errors generated during distance measurement and is the sum of numerous factors. Factors affecting the measurement error ni include variation in wave propagation speed caused by an unstable atmospheric state, thermal noise of a reception circuit, diffraction, scattering, etc. It is assumed that this measurement error conforms to a Gaussian distribution.

In Equation 1, the non-LOS error ei is a very large non-negative error generated when the LOS is not secured. Extensive research has been performed to reduce the non-LOS error.

As one of techniques for reducing the non-LOS error, a method of reducing errors through a process of optimizing a non-linear objective function was disclosed in N. Levanon, “Lowest GDOP in 2-D scenarios,” in Proc. IEE Radar, Sonar and Navigation, vol. 147, June 2000, pp. 149?153. However, this method is very unfavorable in terms of system complexity.

In addition, although an attempt to reduce errors using additional information such as angle of arrival has been made in “An Efficient Geometry-Constrained Location Estimation Algorithm for NLOS Environments”, this method has constraints in that an anchor node should have multiple antennas.

Meanwhile, position measurement needs at least three anchor nodes as described above. A geometric influence of a distance measurement error, (hereinafter, GDOP (Geometric Dilution Of Precision), on a position estimation error may be decreased as the number of anchor nodes in a positioning system is increased. This is because the number of anchor nodes securing a LOS is increased as the number of anchor nodes is increased and thus a probability of securing LOS is increased. Consequently, as the number of anchor nodes in a system is increased, position measurement accuracy is increased.

However, the anchor node consumes substantial installation costs because it is equipment such as a satellite or a cellular base station. In addition, the anchor node is disadvantageous in that it is impossible to flexibly cope with variable demand.

### DISCLOSURE OF INVENTION

### Technical Problem

An object of the present invention devised to solve the problem lies in raising position measurement accuracy by setting a neighboring terminal of a user terminal as a relay terminal and causing the relay terminal to operate like an anchor node.

Another object of the present invention devised to solve the problem lies in simplifying a position measurement process and reducing a position measurement error by setting a neighboring terminal of a user termina securing a LOS as a relay terminal.

The objects of the present invention are not limited to what has been particularly described hereinabove and other objects and advantages of the present invention will be more clearly understood from the embodiment of the present invention which will be described hereinbelow. In addition, it will be easily appreciated that the objectives and other advantages of the invention may be realized by means described in claims and combinations thereof.

### Solution to Problem

The object of the present invention can be achieved by providing a method for measuring the position of a user terminal, including setting one or more anchor nodes for measuring the position of the user terminal, setting neighboring terminals which secure a Line Of Sight (LOS) for the user terminals and contains location information thereof among neighboring terminals of the user terminal as the relay terminals, and measuring the position of the user terminal using the one or more anchor nodes and the one or more relay terminal.

### Advantageous Effects of Invention

According to the present invention, accuracy of position measurement can be raised by setting a neighboring terminal of a user terminal as a relay terminal and causing the relay terminal to operate like an anchor node.

Furthermore, a position measurement process can be simplified and a position measurement error can be reduced by setting a neighboring terminal of a user terminal securing a LOS as a relay terminal.

### BRIEF DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a diagram illustrating a system environment according to an exemplary embodiment of the present invention;

FIG. 2 is a diagram illustrating the configuration of a position measurement apparatus of a user terminal according to an exemplary embodiment of the present invention;

FIG. 3 is a flowchart explaining a whole flow of a position measurement method of a user terminal according to an exemplary embodiment of the present invention;

FIG. 4 is a flowchart explaining a position measurement method of a user terminal in more detail according to an exemplary embodiment of the present invention;

FIG. 5 is a graph comparing GDOP according to the prior art with GDOP according to a position measurement method of an exemplary embodiment of the present invention;

FIG. 6 is a graph illustrating a decreased effect of an estimated volume of confidence by a position measurement method according to an exemplary embodiment of the present invention; and

FIG. 7 is a graph illustrating a decreased effect of a maximum distance error by a position measurement method according to an exemplary embodiment of the present invention.

### BEST MODE FOR CARRYING OUT THE INVENTION

The above and other objects, features and advantages of the present invention will be more clearly understood from the following detailed description taken in conjunction with the accompanying drawings and those skilled in the art will be able to easily implement the technical sprits of the present invention. In describing the present invention, when it is determined that the detailed description of the known art related to the present invention may obscure the gist of the present invention, the detailed description thereof will be omitted. Reference will now be made in detail to the preferred embodiments of the present invention, examples of which are illustrated in the accompanying drawings. The same reference numbers will be used to refer to the same or like parts.

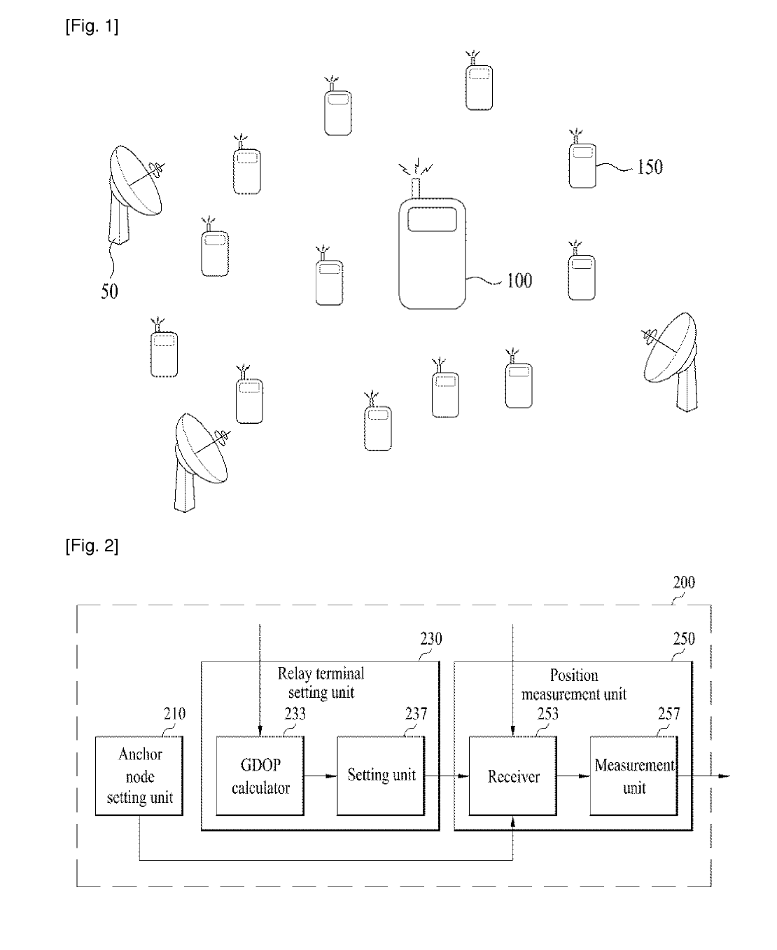

FIG. 1 is a diagram illustrating a system environment according to an exemplary embodiment of the present invention.

Triangulation may be used for position determination. In a system environment according to an exemplary embodiment of the present invention, not only three or more anchor nodes 50 and a user terminal 100 to be measured but also a neighboring terminal 150 of the user terminal 100 which is set as a relay terminal is used for position determination.

As mentioned previously, although it is obvious that better position measurement performance is guaranteed as the number of anchor nodes in a system is increased, it may be practically difficult to add anchor nodes. The present invention can obtain effective performance improvement at low costs by applying a relay scheme to a position estimation scheme. The relay scheme refers to a scheme for performing cooperative communication using a relay node instead of additional installation of a base station and is proposed in cellular communication to increase cell coverage, reduce shadow areas, and obtain diversity gain.

It is assumed in the system environment of the present invention that a plurality of user terminals is present in a given space and each user terminal can operate as a relay node. In this specification, a user terminal operating as a relay node is referred to as a relay terminal.

Hereinafter, an apparatus and method for measuring the position of a user terminal according to an exemplary embodiment of the present invention will be described with reference to FIGS. 2 to 4.

FIG. 2 is a diagram illustrating the configuration of a position measurement apparatus of a user terminal according to an exemplary embodiment of the present invention.

Referring to FIG. 2, a position measurement apparatus 200 of a user terminal according to an exemplary embodiment of the present invention may comprise an anchor node setting unit 210, a relay terminal setting unit 230, and a position measurement unit 250. The relay terminal setting unit 230 may comprise a GDOP calculator 233 and a setting unit 237, and the position measurement unit 250 may include a receiver 253 and a measurement unit 257.

The anchor node setting unit 210 sets anchor nodes for measuring the position of a user terminal. During anchor node setting procedure, the anchor node setting unit 210 can collect only information about anchor nodes securing the LOS. In this case, the number of anchor nodes should be at least three or more and the position measurement may be ceased unless information about at least three anchor nodes is collected. The reason why information about anchor nodes securing LOS is collected is to simplify a position measurement process and to reduce a non-LOS error generated by not guaranteeing LOS.

The relay terminal setting unit 230 sets, as a relay terminal, a neighboring terminal which secures a LOS for a user terminal and has location information thereof, among neighboring terminals of the user terminal. In setting the relay terminal, the reason why a terminal securing a LOS is set as the relay terminal is that setting the terminal guaranteeing LOS as the relay terminal has an effect of increasing the average number of LOS-guaranteed anchor nodes participating in a position measurement process. Although a neighboring terminal satisfying the above condition may be set as the relay terminal, the relay terminal may be set using a Geometric Dilution Of Precision (GDOP) of a neighboring terminal as will be described later. The relay terminal may be a terminal having time information synchronized with an anchor node. Moreover, the relay terminal may operate like an anchor node by transmitting a PRN signal. In another aspect of the present invention, the relay terminal setting unit 230 can set more than on relay terminals.

The GDOP calculator 233 included in the relay terminal setting unit 230 calculates GDOP of a neighboring terminal which securing a LOS for a user terminal and having location information thereof. The setting unit 237 may set a neighboring terminal having the lowest GDOP value as a relay terminal. In addition, the setting unit 237 may set one or more neighboring terminals having a low GDOP value as one or more relay terminals.

GDOP is an index indicating a geometric influence of a distance measurement error on a position estimation error. A geometric influence of a distance measurement error on a position estimation error may differ according to the arrangement of anchor nodes. In other words, a terminal, position of which is to be measured, is estimated to be present in a given area with a probability of a specific value or more and a position estimation error may differ according to a geometric arrangement of anchor nodes.

If anchor nodes are geometrically well arranged, GDOP has a lower value and may have a lower position estimation error in the same distance measurement error situation. That is, the accuracy of position measurement may be raised as a GDOP value of an anchor node becomes lower.

The GDOP value is given as:

$$\begin{matrix}MathFigure 2 & \\ G = \sqrt{trace \{ {( {H}^{T} H )}^{- 1} \}} \\ where \\ H = [ \begin{matrix}\frac{x - {x}_{1}}{{D}_{1}} & \frac{y - {y}_{1}}{{D}_{1}} & \frac{z - {z}_{1}}{{D}_{1}} \\ ⋮ & ⋮ & ⋮ \\ \frac{x - {x}_{i}}{{D}_{i}} & \frac{y - {y}_{i}}{{D}_{i}} & \frac{z - {z}_{i}}{{D}_{i}} \\ ⋮ & ⋮ & ⋮ \\ \frac{x - {x}_{N}}{{D}_{N}} & \frac{y - {y}_{N}}{{D}_{N}} & \frac{z - {z}_{N}}{{D}_{N}}\end{matrix} ] , & [ Math . 2 ]\end{matrix}$$

(x, y, z) denotes the location of a user terminal to be measured, and (xi, yi, zi) denotes the location of an anchor node (where i=1, 2, 3, . . . , N).

In an environment having the same distance measurement error, a position estimation error becomes smaller as a GDOP value is decreased and a minimum value of GDOP is

$$\frac{2}{\sqrt{N}} , when N Ε3 .$$

Accordingly, if a neighboring terminal having the lowest GDOP value is set as a relay terminal, optimal performance can be guaranteed in aspect of GDOP since a geometric influence of a distance measurement error on a position estimation error can be minimized.

The position measurement unit 250 measures the position of a user terminal using anchor nodes and a relay terminal. Since the relay terminal operates like an anchor node as described above, using the relay terminal produces effect as if the anchor node is actually added. In addition, the position measurement unit 250 is able to measure the position of the user terminal using one or more anchor nodes and one or more relay terminal.

More specifically, the receiver 253 included in the position measurement unit 250 receives TOA information for a user terminal from the anchor nodes and the relay terminal. The measurement unit 257 measures the position of the user terminal using the TOA information received by the receiver 253. Position measurement using a TOA scheme is well known and therefore a detailed description thereof will be omitted.

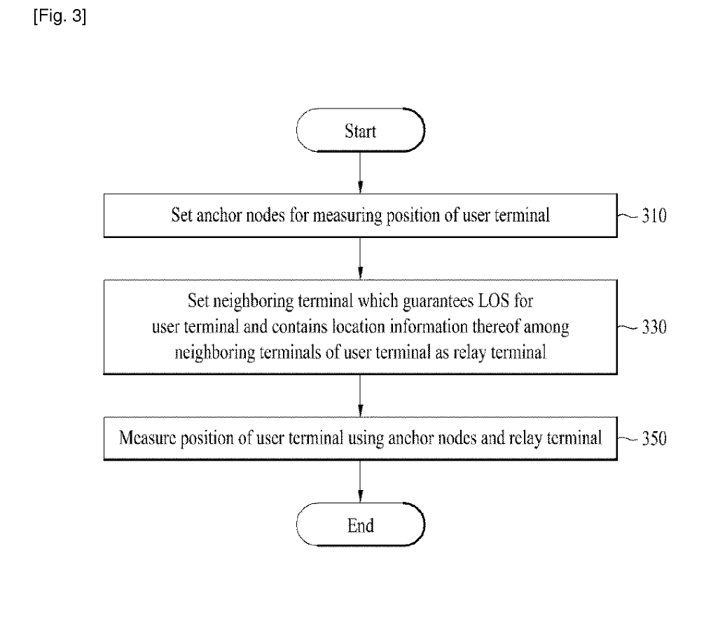

FIG. 3 is a flowchart explaining a whole flow of a position measurement method of a user terminal according to an exemplary embodiment of the present invention.

The procedure described in FIG. 3 can be performed by using the apparatus of FIG. 2.

Referring to FIG. 3, anchor nodes for measuring the position of a user terminal are set (step 310).

In this case, the anchor nodes may be anchor nodes which secure a LOS for the user terminal. Next, a neighboring terminal which secures a LOS for the user terminal and has location information thereof among neighboring terminals of the user terminal is set as a relay terminal (step 330).

The relay terminal may contain time information synchronized with an anchor node in order to operate like the anchor node. In addition, the relay terminal may transmit a PRN signal like an anchor node. Thereafter, the position of the user terminal is measured using the anchor nodes and the relay terminal (step 350).

In this case, the relay terminal may be located at an arbitrary position within a given area or may be located at a predetermined position. As a result, the position measurement method according to the present invention has the effect of measuring the position of the user terminal using a plurality of anchor nodes by setting a neighboring terminal as a relay terminal.

At the step of S350, the position of the user terminal can be measured using the anchor nodes and one or more relay terminals when one or more neighboring terminals were set to the one or more relay terminals.

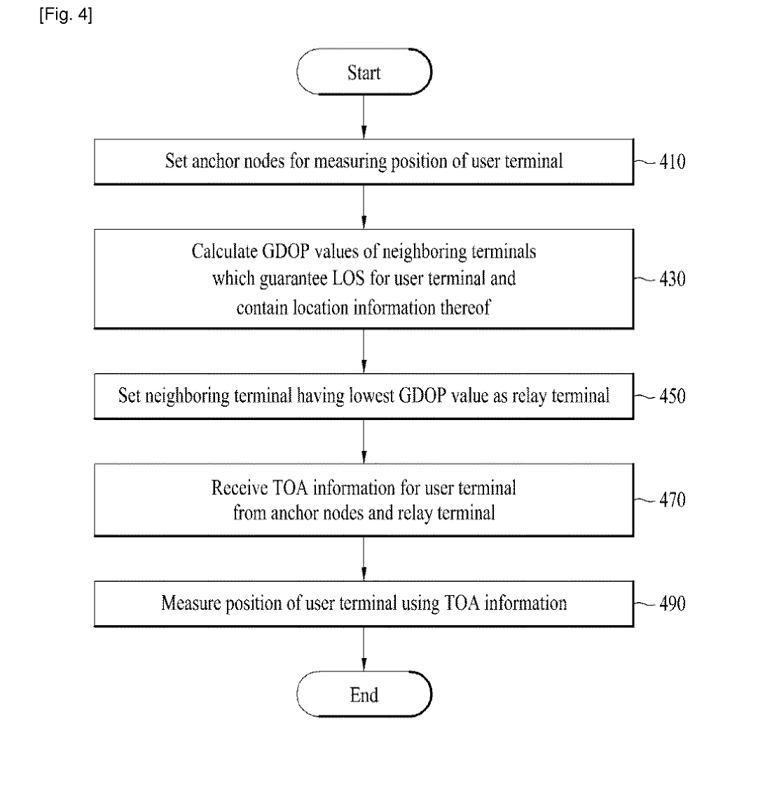

FIG. 4 is a flowchart explaining a position measurement method of a user terminal in more detail according to an exemplary embodiment of the present invention.

The procedure described in FIG. 4 can be performed by using the apparatus of FIG. 2.

Referring to FIG. 4, anchor nodes for measuring the position of a user terminal are set (step 410).

Next, GDOP values of neighboring terminals which secure a LOS for the user terminal and have location information thereof are calculated (step 430).

As a result of calculation, a neighboring terminal having the lowest GDOP value is set as the relay terminal (step 450).

At the step of 450, the relay terminal may have time information synchronized with an anchor node in order to operate as the anchor node. In addition, the relay terminal may transmit a PRN signal like an anchor node.

Thereafter, TOA information for the user terminal is received from the set anchor nodes and relay terminal (step 470) and the position of the user terminal is measured using the TOA information (step S490).

Accordingly, the position of the user terminal is estimated using the anchor nodes and the relay terminal with optimal performance in terms of GDOP and higher accuracy.

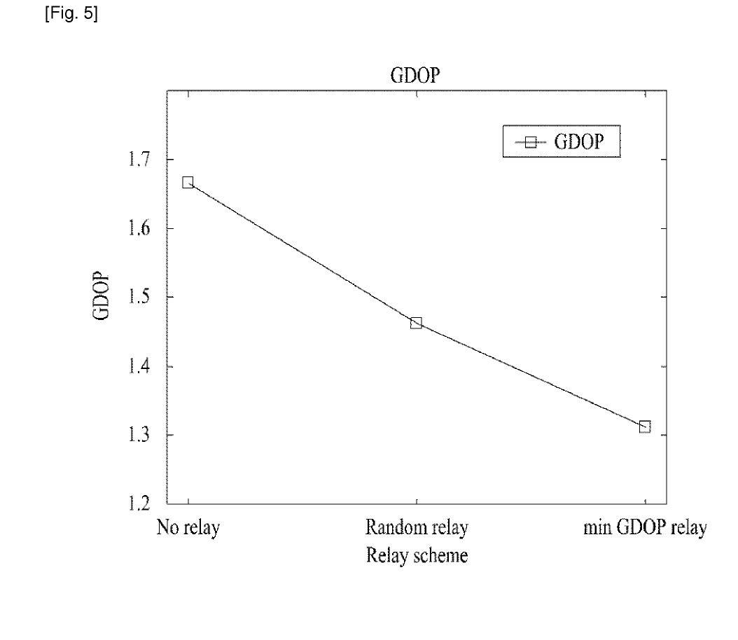

FIG. 5 is a graph comparing GDOP according to the prior art with GDOP according to a position measurement method of an exemplary embodiment of the present invention.

Referring to FIG. 5, an average GDOP value before a relay terminal is applied is 1.6717, whereas GDOP when a relay terminal is randomly set is 1.4651 which is decreased by 12.35% and GDOP when a neighboring terminal having a minimum GDOP is set as a relay terminal is 1.3129 which is decreased by 42.46%. Namely, when using the position measurement method according to an exemplary embodiment of the present invention, high performance gain can be obtained by greatly lowering GDOP.

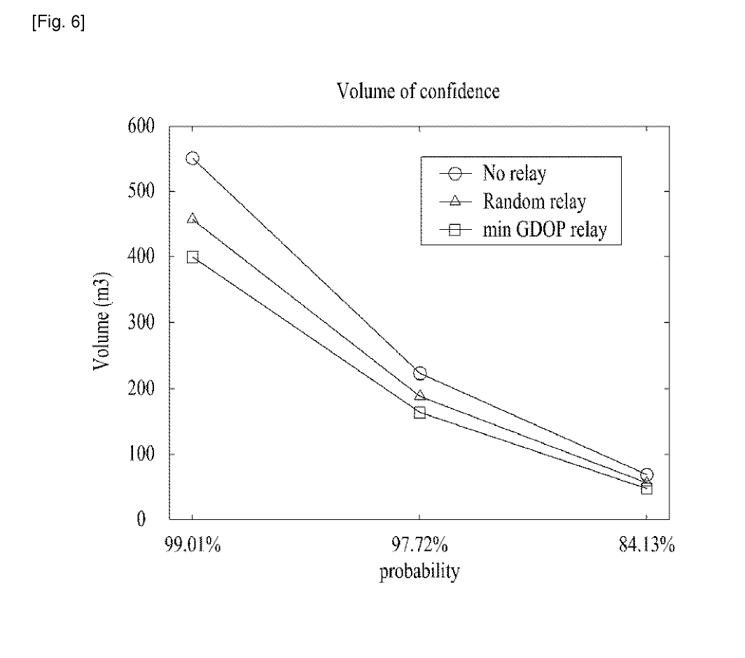

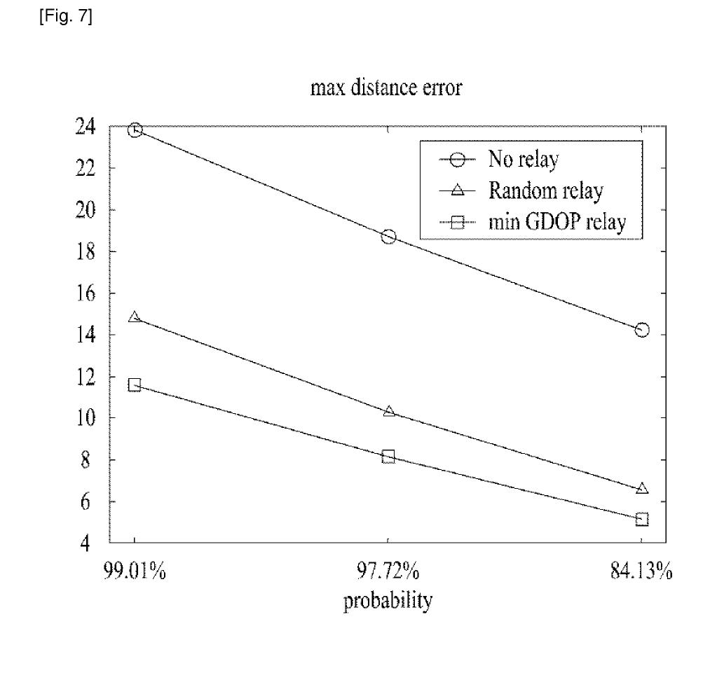

FIG. 6 is a graph illustrating a decreased effect of an estimated volume of confidence by a position measurement method according to an exemplary embodiment of the present invention.

FIG. 6 illustrates a volume of confidence of a region in which a user terminal is estimated to be present at a prescribed probability in the cases where a relay terminal is not used, a relay terminal is randomly set, and a neighboring terminal having a minimum GDOP value is set as a relay terminal.

Referring to FIG. 6, the volume of confidence of a region in which a user terminal is estimated to be present at a probability of 84.13% is decreased by 18.48% when a relay terminal is randomly set and by 29.15% when a neighboring terminal having a minimum GDOP value is set as a relay terminal, compared with the case where a relay terminal is not used.

The volume of confidence of a region in which a user terminal is estimated to be present at a probability of 97.72% is decreased by 15.38% when a relay terminal is randomly set and by 26.49% when a neighboring terminal having a minimum GDOP value is set as a relay terminal, compared with the case where a relay terminal is not used.

The volume of confidence of a region in which a user terminal is estimated to be present at a probability of 99.01% is decreased by 16.98% when a relay terminal is randomly set and by 27.64% when a neighboring terminal having a minimum GDOP value is set as a relay terminal, compared with the case where a relay terminal is not used.

According to the above simulation result, since the volume of confidence of a region in which a user terminal is estimated to be present is decreased when a neighboring terminal having a minimum GDOP value is set as a relay terminal, the accuracy of position measurement is further increased.

FIG. 7 is a graph illustrating a decreased effect of a maximum distance error by a position measurement method according to an exemplary embodiment of the present invention.

FIG. 7 illustrates a maximum distance between an estimated position and an actual position of a user terminal in the case where the user terminal is estimated to be positioned within a prescribed region at a probability denoted in an x axis.

Referring to FIG. 7, a maximum distance error when the position of a user terminal is estimated at a probability of 84.13% is decreased by 54.22% when a relay terminal is randomly set and by 64.23% when a neighboring terminal is set as a relay terminal,

A maximum distance error when the position of a user terminal is estimated at a probability of 97.72% is decreased by 45.19% when a relay terminal is randomly set and by 56.48% when a neighboring terminal is set as a relay terminal, compared with the case where a relay terminal is not used.

A maximum distance error when the position of a user terminal is estimated at a probability of 99.01% is decreased by 37.81% when a relay terminal is randomly set and by 51.28% when a neighboring terminal is set as a relay terminal, compared with the case where a relay terminal is not used.

As shown in the above simulation result, it can be confirmed that a position estimation error is remarkably reduced according to a geometric arrangement when a neighboring terminal having a minimum GDOP value is set as a relay terminal compared with the case in which a relay terminal is not used.

Although addition of a relay terminal does not exert a great effect compared with addition of an anchor node in an environment in which LOS is not considered, addition of the relay terminal has an effect similar to addition of the anchor node in an environment in which LOS is considered.

In addition, since the relay terminal can secure LOS through a great many arbitrary terminals compared with the anchor node in which LOS may or may not be secured according to various situations, performance improvement gain can be obtained by adding the relay terminal in the case where LOS is considered.

Further, setting of the relay terminal considering GDOP is more favorable in terms of

GDOP than setting of the anchor node. In the case of a previously designed anchor node, the anchor node does not always have a low value although it may averagely have the lowest GDOP value. On the other hand, if a neighboring terminal having a minimum GDOP value is set as a relay terminal, there is a high possibility of using a relay terminal having a lower GDOP value by selecting a neighboring terminal having the lowest GDOP value in a given situation. In addition, GDOP approximates to the lowest value as the number of candidate relay terminals is increased.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A method for measuring a position of a user terminal, the method comprising:
selecting one or more anchor nodes for measuring the position of the user terminal;
selecting a relay terminal from neighboring terminals of the user terminal as a relay terminal, each of the neighboring terminals securing a Line Of Sight (LOS) with the user terminal and having location information thereof; and
measuring the position of the user terminal using the one or more anchor nodes and the relay terminal.

2. The method according to claim 1, wherein the step of the selecting a relay terminal comprises:
calculating a Geometric Dilution Of Precision (GDOP) of the neighboring terminals; and
selecting the neighboring terminal having the lowest GDOP value as the relay terminal.

3. The method according to claim 1, wherein the step of the measuring the position of the user terminal comprises:
receiving Time Of Arrival (TOA) information for the user terminal from the one or more anchor nodes and the relay terminal; and
measuring the position of the user terminal using the TOA information.

4. The method according to claim 1, wherein the relay terminal has time information synchronized with the one or more anchor nodes.

5. A method for measuring a position of a user terminal, the method comprising:
selecting at least three anchor nodes for measuring the position of the user terminal;
selecting a relay terminal from neighboring terminals of the user terminal, each of the neighboring terminals securing a Line Of Sight (LOS) with the user terminal and having location information thereof; and
measuring the position of the user terminal using the at least three anchor nodes and the relay terminal.

6. The method according to claim 5, wherein the step of the selecting a relay terminal comprises:
calculating a Geometric Dilution Of Precision (GDOP) of the neighboring terminals; and
selecting the neighboring terminal having the lowest GDOP value as the relay terminal.

7. The method according to claim 5, wherein the step of the measuring the position of the user terminal comprises:
receiving Time Of Arrival (TOA) information for the user terminal from the at least three anchor nodes and the relay terminal; and
measuring the position of the user terminal using the TOA information.

8. The method according to claim 5, wherein the relay terminal has time information synchronized with the at least three anchor nodes.
